(19) United States
(12) Patent Application Publication
(10) Pub. No.: US 2013/0104078 A1
(43) Pub. Date: Apr. 25, 2013

(54) INFORMATION PROCESSING DEVICE AND RECORDING MEDIUM STORING CONTROL PROGRAM USED FOR THE DEVICE

(71) Applicant: Sadaaki MIYAZAKI, Nagoya-shi (JP)

(72) Inventor: Sadaaki MIYAZAKI, Nagoya-shi (JP)

(21) Appl. No.: 13/628,769

(22) Filed: Sep. 27, 2012

(30) Foreign Application Priority Data
Oct. 24, 2011 (JP) 2011-233337

(51) Int. Cl. G06F 3/048

(52) U.S. Cl. 715/833

(57) ABSTRACT

An information processing device includes: (a) a display unit for displaying a representation and receiving an operation that is to be performed, by a user, onto the displayed representation; (b) an icon display controller for displaying, as the representation, a plurality of icons in a first displaying region; (c) an icon scroll controller for scrolling the icons in the a direction, when it is recognized that the received operation is performed in the first displaying region and that the received operation is constituted by a slide movement in the first direction; and (d) a relating-object display controller for displaying, as the representation, a relating object that relates to one the icons displayed in a selected-status indicating manner such that the relating object is displayed in a second displaying region that is offset from the first displaying region in a second direction perpendicular to the first direction.

### BACKGROUND OF THE INVENTION

### Field of the Invention

This application claims priority from Japanese Patent Application No. 2011-233337 filed on Oct. 24, 2011, the disclosure of which is herein incorporated by reference in their entirety.

The present invention relates to an information processing device and a recording medium storing a control program used for the information processing device.

There is conventionally known a display unit with a touch panel. Such a display unit has a display surface on which a transparent panel as the touch panel is superposed so that the display unit can receive a touch operation that is performed on a button graphic displayed on the display surface.

### SUMMARY OF THE INVENTION

However, although there is known a technique relating to a touch operation performed on the button graphic, there is not known a technique relating to a slide operation (such as a flick operation and a drag operation) that is constituted by a slide movement of a user's fingertip or stylus on the display surface.

In the above-described known display unit, when a portion of the display surface in which the button graphic is displayed has been worn, the button graphic is displayed in another portion of the display surface. However, this shift of position of the button graphic causes wear in this another portion of the display surface. Therefore, by repeatedly making such a position shift of the button graphic, there would be a problem that a scratched or dirty region of the display surface is gradually is increased and that a region of the display surface capable of clearly displaying a graphic representation is reduced.

Particularly, where the slide operation is performed on the touch panel, the scratched or dirty region could be easily increased whereby content of the representation is made difficult to be visually confirmed. Consequently, it becomes difficult to carry out an operation with reference to the representation displayed on the display surface.

The present invention was made in view of such a background. It is therefore an object of the invention to make it easy to confirm content of representation displayed on a display surface of a device on which a user's operation is performed by a slide movement of a user's fingertip, stylus or other pointing body.

The above object of the invention may be achieved according to a first aspect of the invention, which provides an information processing device including: (a) an image processor including an image reading unit configured to read an image from an original and/or an image forming unit configured to form an image onto a recording medium; (b) a processing controller configured to control a processing; (c) a display unit configured to display a representation and to receive a user's operation that is to be performed, by a user, onto the displayed representation; (d) a preset option-combination storage configured to store a plurality of preset option combinations, each of the preset option combinations including selected options selected for respective setting items that relate to the processing controlled by the processing controller, each of the selected options being selected from a plurality of selectable options that are selectable for a corresponding one of the setting items; (e) an icon display controller configured to cause the display unit to display, as the representation, a plurality of icons representing the respective preset option combinations such that the plurality of icons are displayed in a first displaying region of the display unit and are arranged in a first direction and such that one of the icons is displayed in a selected-status indicating manner while the other of the icons is displayed in a non-selected-status indicating manner that is different from the selected-status indicating manner; (f) an icon scroll controller configured to cause the display unit to scroll the plurality of icons in the first direction, when it is recognized that the received user's operation is performed in the first displaying region and that the received user's operation performed in the first displaying region is constituted by a slide movement in the first direction; and (g) a relating-object display controller configured to cause the display unit to display, as the representation, a relating object that relates to one of the preset option combinations represented by the one of the icons displayed in the selected-status indicating manner such that the relating object is displayed in a second displaying region that is offset from the first displaying region, by a given distance, in a second direction perpendicular to the first direction. The processing controller is configured, when it is recognized that initiation of the processing is commanded by the received user's operation, to control the processing in accordance with the one of the preset option combinations represented by the one of the icons displayed in the selected-status indicating manner. The processing controller includes an image processing controller configured, when it is recognized that initiation of an image processing as the processing is commanded by the received user's operation, to cause the image processor to carry out the image processing by controlling the image processor in accordance with the one of the preset option combinations.

The above object of the invention may be achieved also according to a second aspect of the invention, which provides an information processing device including: (a) a processing controller configured to control a processing; (b) a display unit configured to display a representation and to receive a user's operation that is to be performed, by a user, onto the displayed representation; (c) a preset option-combination storage configured to store a plurality of preset option combinations, each of the preset option combinations including selected options selected for respective setting items that relate to the processing controlled by the processing controller, each of the selected options being selected from a plurality of selectable options that are selectable for a corresponding one of the setting items; (d) an icon display controller configured to cause the display unit to display, as the representation, a plurality of icons representing the respective preset option combinations such that the plurality of icons are displayed in a first displaying region of the display unit and are arranged in a first direction and such that one of the icons is displayed in a selected-status indicating manner while the other of the icons is displayed in a non-selected-status indicating manner that is different from the selected-status indicating manner; (e) an icon scroll controller configured to cause the display unit to scroll the plurality of icons in the first direction, when it is recognized that the received user's operation is performed in the first displaying region and that the received user's operation performed in the first displaying region is constituted by a slide movement in the first direction; (f) a relating-object display controller configured to cause the display unit to display, as the representation, a relating object that relates to one of the preset option combinations represented by the one of the icons displayed in the selected-status indicating manner such that the relating object is displayed in a second displaying region that is offset from the first displaying region, by a given distance, in a second direction perpendicular to the first direction; (g) a setting-representation display controller configured, when it is recognized that display of the setting items and/or the selected options of the preset option combinations is commanded by the received user's operation, to cause the display unit to display, as the representation, a plurality of setting representations representing the setting items and/or the selected options that are included in the one of the preset option combinations, such that the plurality of setting representations are displayed in a third displaying region of the display unit and are arranged in the second direction; (h) a setting-representation scroll controller configured to cause the display unit to scroll the plurality of setting representations in the second direction, when it is recognized that the received user's operation is performed in the third displaying region and that the received user's operation performed in the third displaying region is constituted by a slide movement in the second direction; (i) a selected option storage controller configured, when it is recognized that change of each of at least one of the selected options included in the one of the preset option combinations into another option is commanded by the received user's operation, to cause a selected option storage to store the another option. The processing controller is configured, when it is recognized that initiation of the processing is commanded by the received user's operation, to control the processing in accordance with the one of the preset option combinations represented by the one of the icons displayed in the selected-status indicating manner. The relating-object display controller is configured to cause the display unit to display the relating object in the second displaying region which is offset from the first displaying region by the given distance in the second direction and which is offset from the third displaying region by a given distance in the first direction.

The above object of the invention may be achieved also according to a third aspect of the invention, which provides a computer-readable recording medium storing a control program that is to be used for the above-described information processing device, wherein the control program stored in the computer-readable recording medium is to be executed for causing a control unit included in the information processing device, to function at least as the above-described processing controller, icon display controller, icon scroll controller and relating-object display controller.

### BRIEF DESCRIPTION OF THE DRAWINGS

The above and other objects, features, advantages and technical and industrial significance of the present invention will be better understood by reading the following detailed description of presently preferred embodiments of the invention, when considered in connection with the accompanying drawings, in which:

FIG. 1A is a block diagram showing an internal construction of a multifunction device;

FIG. 1B is a front view of an operation panel unit of the multifunction device;

FIG. 1C is a view showing components included in a control unit of the multifunction device;

FIG. 2 is a flow chart showing a routine that is carried out when an icon selection page is opened;

FIG. 3 is a flow chart showing a routine that is carried out when a setting-item list page is opened;

FIG. 4 is a flow chart showing a routine that is carried out when a selected-option change page is opened;

FIG. 5 is a view showing an initial display page in which a facsimile-function-selection icon, a copy-function-selection icon and a scan-function-selection icon are displayed;

FIGS. 6A and 6B is a set of views showing the icon selection page;

FIGS. 7A and 7B is a set of views showing the setting-item list page;

FIGS. 8A and 8B is a set of views showing the selected-option change page; and

FIG. 9 is a view showing a combination of a multifunction device and a personal computer.

### DETAILED DESCRIPTION OF THE PREFERRED EMBODIMENTS

There will be described embodiments according to the invention by way of example.

### [Construction of Multifunction Device]

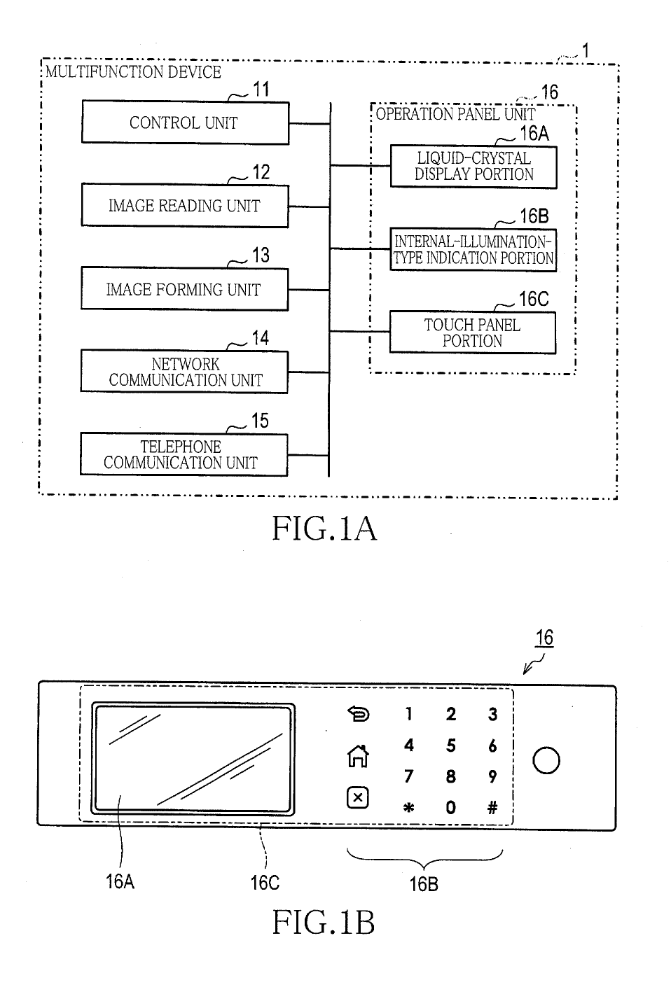

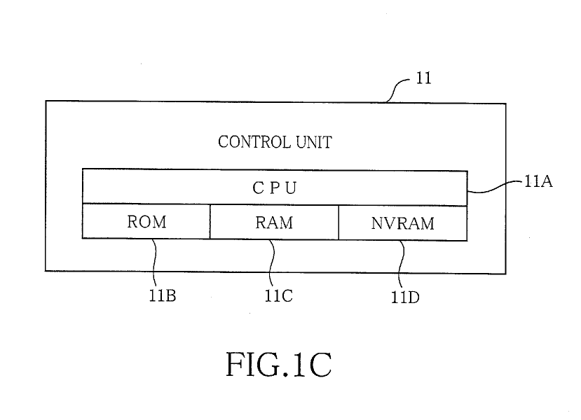

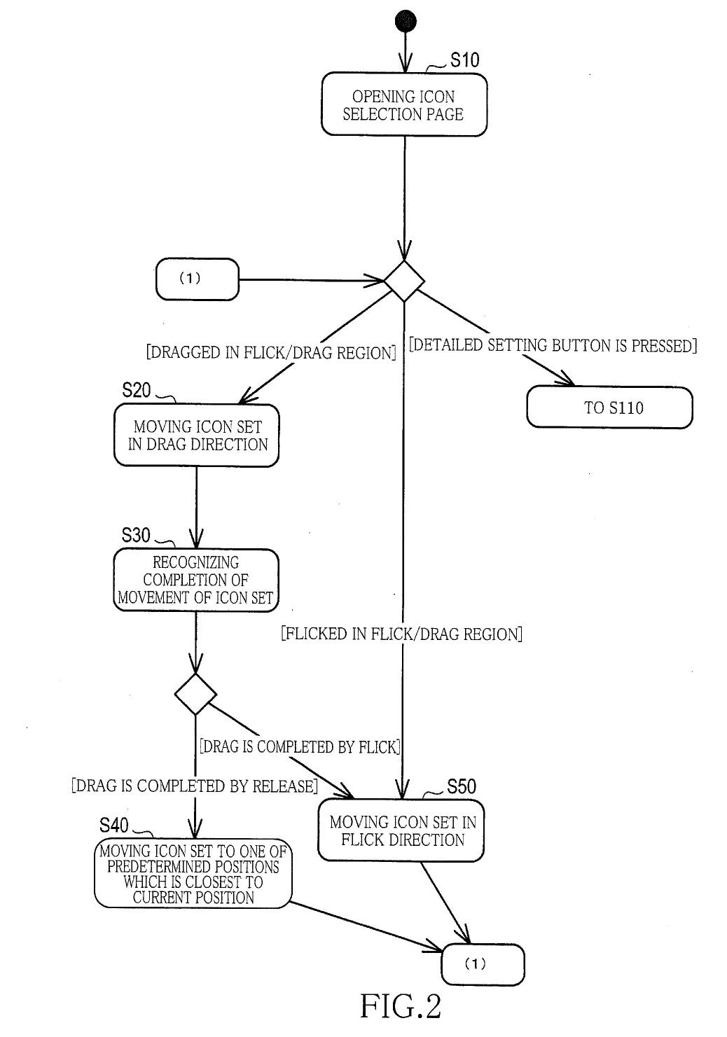

FIG. 1A shows various units that are included in a multifunction device 1 as an information processing device. As shown in FIG. 1A, the multifunction device 1 includes a control unit 11, an image reading unit 12, an image forming unit 13, a network communication unit 14, a telephone communication unit 15 and an operation panel unit 16.

The control unit 11 is constituted principally by a micro computer including known CPU 11A, ROM 11B, RAM 11C and NVRAM 11D, as shown FIG. 1C. In the control unit 11, the CPU 11A carries out below-described processings in accordance with programs stored in the ROM 11B, for thereby controlling the various units of the multifunction device 1. In this embodiment, the ROM 11B serves as computer-readable recording medium

In the image reading unit 12 including an image sensor and an automatic document feeder, which is abbreviated to as ADF, the image sensor reads an image from an original document that is to be fed by the ADF or placed on a platen glass of a flat bed, and an image data representing the read image is generated. The image forming unit 13 is an unit employing an inkjet printing system or an electrophotographic printing system, and is capable of recording an image onto a recording medium in the form of a recording sheet (e.g., recording paper sheet). In the present embodiment, the control unit 11 constitutes a processing controller, a preset option-combination storage, an icon display controller, an icon scroll controller, a relating-object display controller, a setting-representation display controller, a setting-representation scroll controller and a selected option storage controller, while each of the image reading unit 12 and the image forming unit 13 constitutes an image processor.

The network communication unit 14 includes a network interface card, which is abbreviated to as NIC. The telephone communication unit 15 includes a modem, and is used for a communication via a telephone line, which is not shown in the drawings.

The operation panel unit 16 includes a liquid-crystal display portion 16A, an internal-illumination-type indication portion 16B and a touch panel portion 16C. The liquid-crystal display portion 16A is constituted by a display device having LCD modules capable of displaying desired graphic representations with full-colors. The operation panel unit 16 is configured to dynamically display, on its display surface provided by the liquid-crystal display portion 16A, representations in the form of various icons, button graphics, letter strings and texts representing various informations, depending on an operational state. In the present embodiment, the operation panel unit 16 corresponds to a display unit.

As shown in FIG. 1B, ten-keys and other button graphics, which are to be subjected to a user's operation, are displayed on the internal-illumination-type indication portion 16B. On a front panel of the internal-illumination-type indication portion 16B, light transmission portions are provided in respective positions that are positionally aligned with the respective button graphics, so that each of the button graphics is displayed with a given color by a light transmitted through the corresponding light transmission portion when a light emitting light disposed behind the corresponding light transmission portion is activated. It is noted that the display surface of the liquid-crystal display portion 16A lies on the same surface as a display surface of the internal-illumination-type indication portion 16B.

The touch panel portion 16C is constituted by an input device which includes a transparent film-like body and which is capable of detecting, by means of a known system such as a capacitance system, a touch operation that is performed by a pointing body such as a user's fingertip, pen and stylus. This touch panel portion 16C is superposed on the display surfaces of the liquid-crystal display portion 16A and the internal-illumination-type indication portion 16B. In the present embodiment, when the touch operation is detected by the touch panel portion 16C, the control unit 11 receives an output signal supplied from the touch panel portion 16C. The output signal is a position information representing a position of a portion of the display surface of the liquid-crystal display portion 16A or the internal-illumination-type indication portion 16B with which the pointing body is brought into contact. The control unit 11 judges, based on the output signal, whether the touch operation is constituted by a slide operation that is a general concept including a drag operation and a flick operation, a tap operation that is a general concept including a single-tap operation and a double-tap operation, or a pinch operation. Further, the control unit 11 also judges, based on the output signal, whether or not the touch operation is performed onto the display surface of the liquid-crystal display portion 16A and whether or not the touch operation is performed onto the button graphics displayed in the internal-illumination-type indication portion 16B. Thus, the control unit 11 recognizes a type of the performed touch operation and a position in which the touch operation is performed. Then, the control unit 11 executes a processing that is selected based on the type and position of the touch operation.

### [Input/Output Processings]

Referring next to flow charts of FIGS. 2-4, there will be described input/output processings that are to be executed when a touch operation is performed in the operation panel unit 16 of the multifunction device 1. In the following description, there will be described the input/output processings (such as a touch-operation detection processing and a display output processing) that are to be executed, particularly, in a case of change of a selected option for a setting item that relates to a copy function. It should be noted that, also in a case of change of a selected option for a setting item that relates to another function such as a scan function and a facsimile function, a user's operation and a display procedure are performed basically in the same manners as described below.

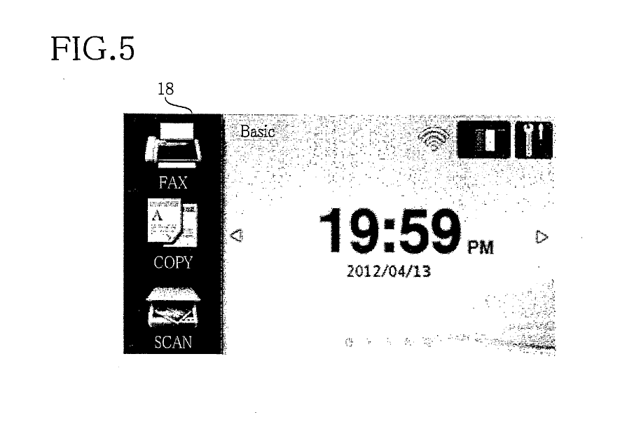

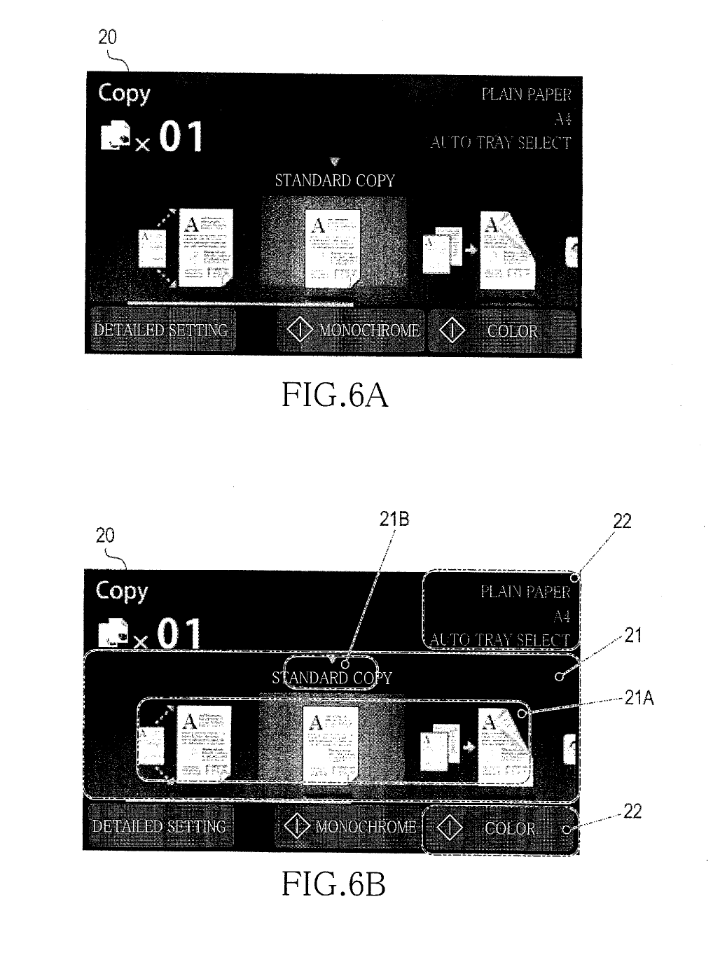

FIG. 5 shows an initial display page 18 that is opened in the operation panel unit 16 of the multifunction device 1 when a power switch of the multifunction device 1 is turned on. The initial display page 18 contains a facsimile-function-selection icon, a scan-function-selection icon and a copy-function-selection icon, so as to serves as a page for enabling a user to select one of the copy function, scan function and facsimile function, which is to be performed by the multifunction device 1. When the copy function is selected by selecting the copy-function-selection icon displayed in the initial display page, the control unit 11 opens a copy-function-preset-option-combination icon selection page 20 as shown in FIGS. 6A and 6B (step S10). The copy-function-preset-option-combination icon selection page 20 is a page for enabling a user to select one of a plurality of copy-function-related preset option combinations stored in the preset option-combination storage that is included in the control unit 11. Each of the copy-function-related preset option combinations includes selected options selected for respective setting items that relate to the copy function, wherein each of the selected options is selected from a plurality of selectable options that are selectable for a corresponding one of the setting items. It is noted that, when the scan function or facsimile function is selected by selecting the scan-function-selection icon or facsimile-function-selection icon displayed in the initial display page 18, the control unit 11 opens a scan-function-preset-option-combination icon selection page or a facsimile-function-preset-option-combination icon selection page which are similar to the copy-function-preset-option-combination icon selection page 20. The scan-function-preset-option-combination icon selection page or facsimile-function-preset-option-combination icon selection page is a page for enabling the user to select one of a plurality of scan-function-related preset option combinations or facsimile-function-related preset option combinations stored in the preset option-combination storage. Each of the scan or facsimile-function-related preset option combinations includes selected options selected for respective setting items that relate to the scan or facsimile function, wherein each of the selected options is selected from a plurality of selectable options that are selectable for a corresponding one of the setting items.

The copy-function-preset-option-combination icon selection page 20 contains a representation in the form of (i) letter strings representing options selected for the respective setting items such as a number of copies, a media type, a media size and an exit tray setting; (ii) a plurality of copy-function-preset-option-combination icons corresponding to the plurality of copy-function-related preset option combinations; (iii) a letter string (i.e., information text) corresponding to one of the copy-function-preset-option-combination icons which is displayed in a selected-status indicating manner; and (iv) button graphs such as a detailed setting button, a monochrome-copy start button and a color-copy start button. In a case illustrated in FIGS. 6A and 6B, as the letter string representing the selected options, there are displayed “plain paper” that is selected for the media type as the setting item, “A4” that is selected for the media size as the setting item and “auto tray” that is selected for the exit tray setting as the setting item. Further, in the illustrated case, the currently-selected one of the icons is displayed with a rectangular frame surrounding the currently selected icon, and “standard copy” is displayed as the letter string corresponding to the currently selected icon. It is noted that all of the copy-function-preset-option-combination icons are not displayed at a time in the copy-function-preset-option-combination icon selection page 20. Rather, a number of the icons (i.e., the number of the preset option combinations), which are displayed at a time, is equal to a maximum number of icons that are displayable at a time. It is further noted that, when the scan-function-preset-option-combination icon selection page or facsimile-function-preset-option-combination icon selection page is opened, a plurality of scan-function-preset-option-combination icons or facsimile-function-preset-option-combination icons corresponding to the plurality of scan or facsimile-function-related preset option combinations are displayed in place of the copy-function-preset-option-combination icons.

When the copy-function-preset-option-combination icon selection page (hereinafter referred to simply as “icon selection page”) 20, scan-function-preset-option-combination icon selection page or facsimile-function-preset-option-combination icon selection page is being opened in the liquid-crystal display portion 16A, there are existed a first displaying region 21 and a second displaying region 22 that is other than the first displaying region 21, on the touch panel portion 16C, as shown in FIG. 6B. The second displaying region 22 includes upper and lower sections that are spaced apart from each other in a vertical direction. The control unit 11 effectively receives an initiation of the slide operation as long as the slide operation is performed in the first displaying region 21. However, the control unit 11 never effectively receives an initiation of the slide operation when the slide operation is performed in the second displaying region 22 rather than in the first displaying region 21, not only when the icon selection page 20 is being opened but also when any other page is being opened as a result of procedure described below. In other words, the control unit 11 does not effectively receives the user's operation, as long as the user's operation is performed in the second displaying region 22 rather than in the first displaying region 21, even with a recognition that the received user's operation is constituted by a slide movement.

The control unit 11 monitors the output signal outputted from the touch panel unit 16C, periodically, for example, every 50 milliseconds. When the position represented by the output signal outputted from the touch panel unit 16C is located in the first displaying region 21 at a point of time after absence of the output signal for at least a predetermined length of time and then the position represented by the output signal is displaced in a constant direction during a period following the point of time, the control unit 11 judges that a drag operation is performed. Further, when the position represented by the output signal is displaced at least a given acceleration after the judgment that the drag operation is performed, the control unit 11 judges that the drag operation has been completed by a flick operation. When the output signal is not outputted from the touch panel portion 16C for a given length of time without the judgment of the completion of the drag operation by the flick operation, after the above-described judgment of the performance of the drag operation, the control unit 11 judges that the drag operation has been completed by a release operation (i.e., an operation constituted by an upward release movement of the pointing body away from the touch panel portion 16C). However, when the position represented by the output signal outputted from the touch panel unit 16C is located in the second displaying region 22 after absence of the output signal for at least a predetermined length of time, the control unit 11 does not judge whether a drag operation is performed.

When the drag operation is performed in a horizontal direction (i.e., a rightward or leftward direction) in the first displaying region 21 after the icon selection page 20 is opened at step S10, the control unit 11 causes the operation panel unit 16 to move the icon set (i.e., the plurality of icons) in the horizontal direction in which the drag operation is performed, at step S20. When the drag operation is completed, the control unit 11 causes the operation panel unit 16 to finish movement of the icon set at step S30.

When the drag operation is completed by the release operation, the control unit 11 causes the operation panel unit 16 to move the icon set to one of predetermined positions which is the closest to a current position (i.e., a position of the icon set at a point of time at which the drag operation is completed by the release operation) at step S40. That is, although the icon set is moved in a response to the drag operation, the icon set is stopped when arriving in the above-described one of the predetermined positions, rather than being stopped immediately when the drag operation is completed by the release operation. Thus, the icon set is positioned in one of the predetermined positions. After implementation of step S40, the control flow goes to (1), as shown in FIG. 2.

On the other hand, when the drag operation is completed by the flick operation after implementation of step S30, or when the flick operation is performed after implementation of step S10, step S50 is implemented so that the control unit 11 causes the operation panel unit 16 to move the icon set in a direction of the flick operation upon detection of the flick operation by the touch panel portion 16C.

The control unit 11 calculates velocity or acceleration of the position represented by the output signal outputted from the touch panel portion 16C during the flick operation, and causes the operation panel unit 16 to start moving the icon set at a velocity that is dependent on the calculated velocity or acceleration. Then, the velocity of the icon set is gradually reduced, and the icon set is eventually stopped in the closest one of the predetermined positions when the reduced velocity becomes close to zero. After implementation of step S50, the control flow goes to (1), as shown in FIG. 2.

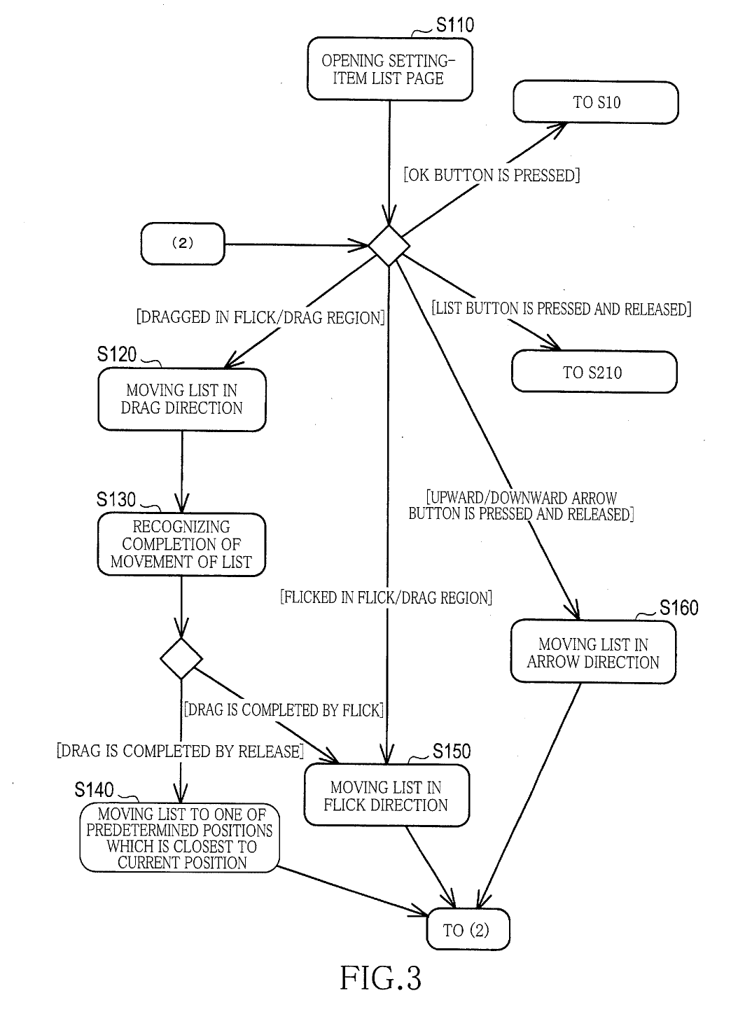

Further, after implementation of step S10, the touch operation performed onto the button graphic such as the detailed setting button, monochrome-copy start button and color-copy start button is also detected by the touch panel portion 16C. When the touch panel portion 16C detects that the detailed setting button is pressed, the control flow goes to step S110 shown in FIG. 3. When the touch panel portion 16C detects that the monochrome-copy start button or color-copy start button is pressed, the control unit 10 controls the image reading unit 12 and the image forming unit 13 in accordance with a currently-selected one of the plurality of preset option combinations, whereby a copy processing is carried out in the multifunction device 1. It is noted that FIG. 2 shows user-interface-related activities (i.e., procedures) as a part of the routine that is carried out when the icon selection page is opened while not showing details relating to the copy processing.

When the control flow goes to step S110, as shown in FIG. 3, the control unit 11 causes the operation panel unit 16 to open the setting-item list page 30. The setting-item list page 30 is a page for displaying a plurality of setting representations representing the setting items and the selected options that are included in the currently-selected one of the preset option combinations. It is noted that all of the setting items and selected options, which are included in the currently-selected one of the preset option combinations, are not displayed at a time. Rather, a number of the setting items and a number of the selected options, which are displayed at a time, are equal to a maximum number of items and a maximum number of options, respectively, which are displayable at a time.

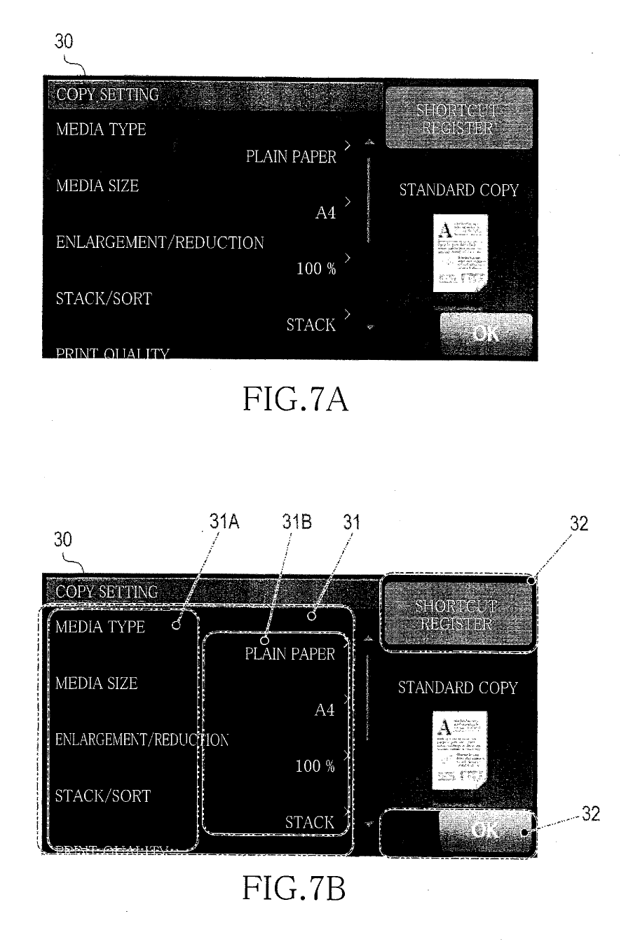

The setting-item list page 30 contains a representation in the form of (i) a page title, (ii) a plurality of setting items, (iii) options selected for the respective setting items, (iii) a scroll bar for scrolling the setting items so as to display one or ones of the setting items which do not appear in the screen and also one or ones of the selected options which do not appear in the screen, (iv) a shortcut register button, (v) an icon representing the currently-selected preset option combination and (vi) an OK button. In a case illustrated in FIGS. 7A and 7B, there are displayed “copy setting” as the page title, “media type”, “media size”, “enlargement/reduction”, “stack/sort” as the setting items, and “plain paper”, “A4”, “100%”, “stack” as the selected options.

When the setting-item list page 30 is being opened in the liquid-crystal display portion 16A, there are existed a third displaying region 31 and a second displaying region 32 that is other than the third displaying region 31, on the touch panel portion 16C, as shown in FIG. 7B. The second displaying region 32 includes upper and lower sections that are spaced apart from each other in the vertical direction. The control unit 11 effectively receives an initiation of the slide operation as long as the slide operation is performed in the third displaying region 31. However, the control unit 11 never effectively receives an initiation of the slide operation when the slide operation is performed in the second displaying region 32 rather than in the third displaying region 31. In other words, the control unit 11 does not effectively receives the user's operation, as long as the user's operation is performed in the second displaying region 32 rather than in the third displaying region 31, even with a recognition that the received user's operation is constituted by a slide movement. It is noted that the second displaying region 32 is constituted by portions of the display surface of the liquid-crystal display portion 16A, which constitute also the above-described second displaying region 22 (see FIG. 6B and FIG. 7B). It is also noted that the third displaying region 31 is partially constituted by a portion of the display surface of the liquid-crystal display portion 16A, which constitutes a part of the above-described first displaying region 21 (see FIG. 6B and FIG. 7B). That is, the third displaying region 31 partially overlaps with the first displaying region 21.

The control unit 11 effectively receives the user's operation performed in the third displaying region 31, and makes judgments on the basis of the output signal outputted from the touch panel unit 16C, in the same manners as when the icon selection page 20 is being opened. However, the control unit 11 does not make judgments regarding the operation performed in the second displaying region 32, even upon reception of the output signal outputted from the touch panel unit 16C, as long as the position represented by the output signal is located in the second displaying region 32.

When the drag operation is performed in a vertical direction (i.e., an upward or downward direction) in the third displaying region 31 after the setting-item list page 30 is opened at step S110, the control unit 11 causes the operation panel unit 16 to move the list (i.e., letter strings representing the plurality of setting items and selected options and arranged in the vertical direction) in the vertical direction in which the drag operation is performed, at step S120. When the drag operation is completed, the control unit 11 causes the operation panel unit 16 to finish movement of the list at step S130.

When the drag operation is completed by the release operation, the control unit 11 causes the operation panel unit 16 to move the list to one of predetermined positions which is the closest to a current position (i.e., a position of the list at a point of time at which the drag operation is completed by the release operation) at step S140. That is, although the list is moved in a response to the drag operation, the list is stopped when arriving in the above-described one of the predetermined positions, rather than being stopped immediately when the drag operation is completed by the release operation. Thus, the list is positioned in one of the predetermined positions. After implementation of step S140, the control flow goes to (2), as shown in FIG. 3.

On the other hand, when the drag operation is completed by the flick operation after implementation of step S130, or when the flick operation is performed after implementation of step S110, step S150 is implemented so that the control unit 11 causes the operation panel unit 16 to move the list in a direction of the flick operation upon detection of the flick operation by the touch panel portion 16C. After implementation of step S150, the control flow goes to (2), as shown in FIG. 3.

When the touch panel portion 16C detects that either one of upward/downward arrow buttons that are located in respective upper and lower end portions of the scroll bar is pressed after implementation of S110, the control unit 11 causes the operation panel unit 16 to move the list in an arrow direction (i.e, the upward direction if the upward arrow button is pressed, or the downward direction if the downward arrow button is pressed) at step S160. After implementation of step S160, the control flow goes to (2), as shown in FIG. 3.

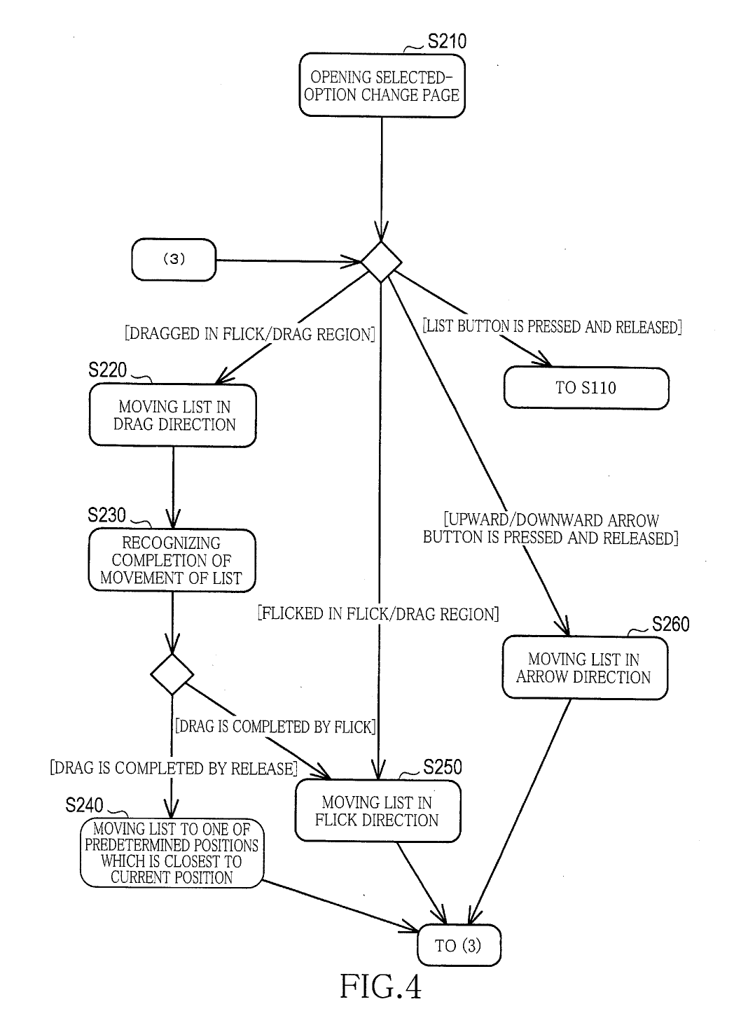

Further, after implementation of step S110, the touch operation performed onto the button graphic such as list buttons (i.e, buttons corresponding to the setting items), shortcut register button and OK button is also detected by the touch panel portion 16C. When the touch panel portion 16C detects that the OK button is pressed, the control flow goes to step S10 shown in FIG. 2. When the touch panel portion 16C detects that any one of the list buttons is pressed and released, the control flow goes to step S210 shown in FIG. 4.

When the control flow goes to step S210 shown in FIG. 4, the control unit 11 causes the operation panel unit 16 to open a selected-option change page 40. The selected-option change page 40 is a page for displaying letter strings representing a plurality of options selectable for one of the setting items which is currently subjected to the change.

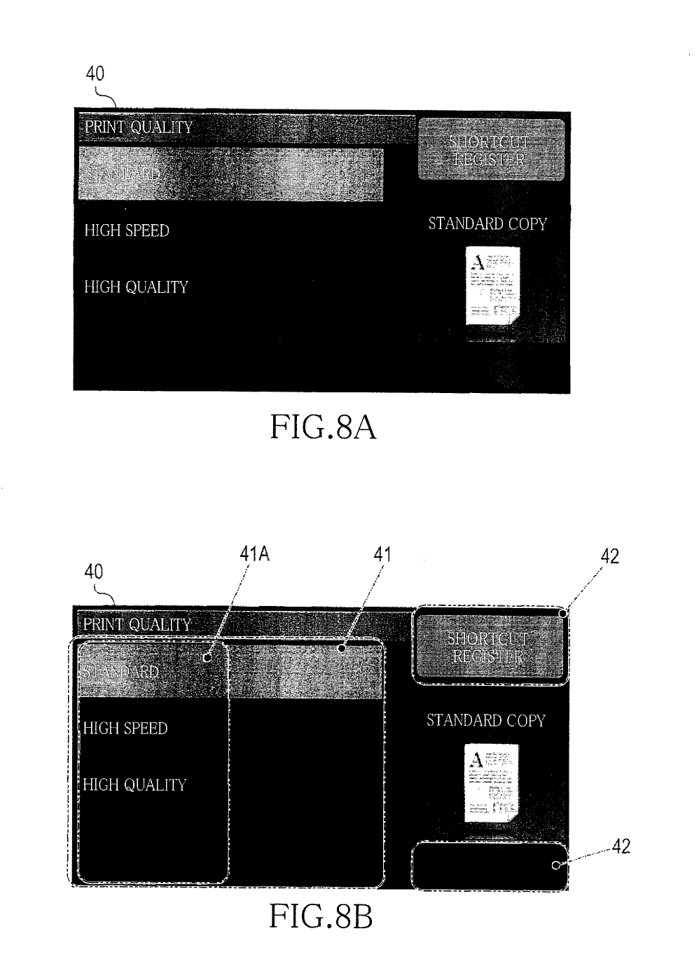

The selected-option change page 40 contains a representation in the form of (i) a stetting item subjected to the change, (ii) options selectable for the setting item, (iii) a shortcut register button and (iv) an icon representing a currently-selected one of the preset option combinations. In a case illustrated in FIGS. 8A and 8B, there are displayed “print quality” as the setting item and “standard”, “high speed”, “high quality” as the selectable options. Although the scroll bar is not displayed in the case illustrated in FIGS. 8A and 8B, the scroll bar is displayed as in the setting-item list page 30 (see FIGS. 7A and 7B) when the number of the selectable options is so large that all of the selectable options cannot be displayed at a time.

When the selected-option change page 40 is being opened in the liquid-crystal display portion 16A, there are existed a third displaying region 41 and a second displaying region 42 that is other than the third displaying region 41 on the touch panel portion 16C, as shown in FIG. 8B. The second displaying region 42 includes upper and lower sections that are spaced apart from each other in a vertical direction. The control unit 11 effectively receives an initiation of the slide operation as long as the slide operation is performed in the third displaying region 41. However, the control unit 11 never effectively receives an initiation of the slide operation when the slide operation is performed in the second displaying region 42 rather than the third displaying region 41. In other words, the control unit 11 does not effectively receives the user's operation, as long as the user's operation is performed in the second displaying region 42 rather than in the third displaying region 41, even with a recognition that the received user's operation is constituted by a slide movement. That is, the control unit 11 never effectively receives an initiation of the slide operation as long as the slide operation is performed in a region of the touch panel portion 16C, which serves as the second displaying region 22, 32, 42, no matter which page is being opened. It is noted that the second displaying region 42 is constituted by portions of the display surface of the liquid-crystal display portion 16A, which constitute also the above-described second displaying region 22, 32 (see FIG. 6B, FIG. 7B and FIG. 8B). It is also noted that the third displaying region 41 is partially constituted by a portion of the display surface of the liquid-crystal display portion 16A, which constitutes a part of the above-described first displaying region 21 (see FIG. 6B and FIG. 8B). That is, the third displaying region 41 partially overlaps with the first displaying region 21.

The control unit 11 effectively receives the user's operation performed in the third displaying region 41, and makes judgments on the basis of the output signal outputted from the touch panel unit 16C, in the same manners as when the icon selection page 20 or setting-item list page 30 is being opened. However, the control unit 11 does not make judgments regarding the operation performed in the second displaying region 42, even upon reception of the output signal outputted from the touch panel unit 16C, as long as the position represented by the output signal is located in the second displaying region 42.

When the drag operation is performed in a vertical direction (i.e., an upward or downward direction) in the third displaying region 41 after the selected-option change page 40 is opened at step S210, the control unit 11 causes the operation panel unit 16 to move the list (i.e., letter strings representing the plurality of selectable options arranged in a vertical direction) in the vertical direction in which the drag operation is performed, at step S220. When the drag operation is completed, the control unit 11 causes the operation panel unit 16 to finish movement of the list at step S230.

When the drag operation is completed by the release operation, the control unit 11 causes the operation panel unit 16 to move the list to one of predetermined positions which is the closest to a current position (i.e., a position of the list at a point of time at which the drag operation is completed by the release operation) at step S240. That is, although the list of the selectable options is moved in a response to the drag operation, the list is stopped when arriving in the above-described one of the predetermined positions, rather than being stopped immediately when the drag operation is completed by the release operation. After implementation of step S240, the control flow goes to (3), as shown in FIG. 4.

On the other hand, when the drag operation is completed by the flick operation after implementation of step S230, or when the flick operation is performed after implementation of step S210, step S250 is implemented so that the control unit 11 causes the operation panel unit 16 to move the list in a direction of the flick operation upon detection of the flick operation by the touch panel portion 16C. After implementation of step S250, the control flow goes to (3), as shown in FIG. 4.

Although the scroll bar is not displayed in the case illustrated in FIGS. 8A and 8B, the scroll bar is displayed when the number of the selectable options is so large that all of the selectable options cannot be displayed at a time. When the scroll bar is displayed, there is a case in which one of the upward/downward arrow buttons located in respective upper and lower end portions of the scroll bar is pressed after implementation of step S210. When the touch panel portion 16C detects that either one of the upward/downward arrow buttons is pressed, the control unit 11 causes the operation panel unit 16 to move the list in an arrow direction (i.e, the upward direction if the upward arrow button is pressed, or the downward direction if the downward arrow button is pressed) at step S260. After implementation of step S260, the control flow goes to (3), as shown in FIG. 4.

Further, after implementation of step S210, the touch operation performed onto the button graphic such as list buttons (i.e, buttons corresponding to the selectable options) and shortcut register button is also detected by the touch panel portion 16C. When the touch panel portion 16C detects that any one of the list buttons is pressed and released, the corresponding option is selected (i.e., validated) and then the control flow goes to step S110 shown in FIG. 3.

There have been described the display pages that are opened in the case of change of a selected option for a setting item relating to the copy function and also the operations performed when each of the display pages is being opened. When the icon selection page 20 is being opened, as shown in FIGS. 6A and 6B, the slide operation is performed in the first displaying region 21 so that the first displaying region 21 is easier to be scratched or get dirty than the other regions. Particularly, a section 21A of the first displaying region 21 is more likely to be easy to be scratched or get dirty than the other sections of the first displaying region 21, because the icons are displayed in the section 21A so that the section 21A is highly frequently rubbed in the horizontal direction (i.e., rightward or leftward direction).

However, in the multifunction device 1 according to the embodiment of the invention, an information text (i.e., letter string “standard copy” in the example illustrated in FIGS. 6A and 6B) relating to the icon displayed in the selected-status indicating manner is displayed in a section 21B that is offset from the above-described section 21A in which the icons are displayed, in a vertical direction that is perpendicular to the slide operation direction. Therefore, as compared with an arrangement in which the same kind of information is displayed in the section 21A, a reduction of visibility of the information text due to scratch or dirt of the section 21A can be avoided.

When the setting-item list page 30 or selected-option change page 40 is being opened, as shown in FIGS. 7A, 7B, 8A and 8B, the slide operation is performed in the third displaying region 31, 41 so that the third displaying region 31, 41 is easier to be scratched or get dirty than the other regions. Particularly, a section 31A, 41A of the third displaying region 31, 41 is more likely to be easy to be scratched or get dirty than the other sections of the first displaying region 21, because the letter strings of the list are displayed in the section 31A, 41A so that the section 31A, 41A is highly frequently rubbed in the vertical direction (i.e., upward or downward direction).

However, in the multifunction device 1 according to the embodiment of the invention, an information text representing the selected options is displayed in a section 31B that is offset from the above-described section 31A, 41A in which the letter strings of the list are displayed, in a horizontal direction that is perpendicular to the slide operation direction. Therefore, as compared with an arrangement in which the same kind of information is displayed in the section 31A, 41A, a reduction of visibility of the information text due to scratch or dirt of the section 31A, 41A can be avoided.

As described above, the second displaying region 22, 32, 42 does not overlap with any one of the first displaying region 21 and third displaying region 31, 41. Therefore, since the second displaying region 22, 32, 42 is not a region in which the slide operation is to be performed, it is possible to prevent the second displaying region 22, 32, 42 from being scratched or getting dirty due to the slide operation. The important information is displayed in the second displaying region 22, 32, 42 that is substantially free from scratch and dirt, and accordingly can be clearly visualized. It is therefore possible to perform the slide operation in the first displaying region 21 or third displaying region 31, 41, while confirming the information clearly displayed in the second displaying region 22, 32, 42.

For example, in the above-described embodiment, the operation panel unit 16 as the display unit is configured to display the representation relating to a currently-selected one of the preset option combinations, in the second displaying region 22, 32, 42. Described specifically, the selected options selected for the respective setting items are displayed in the second displaying region 22, and the shortcut register button (i.e., button graphic for registering the currently-selected preset option combination as a shortcut menu) is displayed in the second displaying region 32, 42. These relating objects relating to the currently-selected preset option combination serves as an information and a button graphic that are important for the user who performs operation relating to the currently-selected preset option combination. Therefore, with the relating objects being displayed in the second displaying region 22, 32, 42, it is possible to improve an operability and to prevent an erroneous operation.

### [Technical Advantages]

As described above, in the multifunction device 1, the second displaying region 22, 32, 42 is harder to be scratched or get dirty as compared with the first displaying region 21 in which an initiation of the slide operation is effectively received by the control unit 11. Since the relating objects (such as the currently selected options displayed in the second displaying region 22 and the shortcut register button displayed in the second displaying region 32, 42) are displayed in the second displaying region 22, 32, 42, the contents of the relating objects can be easily confirmed and the operation directed to the relating objects can be easily performed on the operation panel unit 16.

Further, in the multifunction device 1, the second displaying region 22, 32, 42 is offset from the first displaying region 21 by a given distance in a second direction perpendicular to a first direction, i.e., a direction of the user's slide operation that is effectively received in the first displaying region 21. Therefore, the second displaying region 22, 32, 42 is hard to be scratched or get dirty by the user's fingertip during the slide operation, so that the contents of the relating objects displayed in the second displaying region 22, 32, 42 can be easily confirmed and the operation directed to the relating objects can be easily performed.

Further, in the multifunction device 1, the second displaying region 22, 32, 42 is offset from the third displaying region 31, 41 by a given distance in the first direction perpendicular to the second direction, i.e., a direction of the user's slide operation that is effectively received in the third displaying region 31, 41. Therefore, the second displaying region 22, 32, 42 is hard to be scratched or get dirty by the user's fingertip during the slide operation, so that the contents of the relating objects displayed in the second displaying region 22, 32, 42 can be easily confirmed and the operation directed to the relating objects can be easily performed.

Further, in the multifunction device 1, the color-copy start button is displayed in the second displaying region 22, and the OK button is displayed in the second displaying region 32. That is, these button graphics are displayed in the second displaying region 22, 32 rather than in the first displaying region 21 and third displaying region 31, 41 that are relatively easy to be scratched or get dirt, so that these displayed button graphics can be well visualized. Still further, the color-copy start button as a first button graphic is displayed in a first position located in the second displaying region 22, and the OK button as a second button graphic is displayed in a second position located in the second displaying region 32. Since the first and second positions overlap with each other, both of the first and second button graphics can be operated by the operation performed in a common portion of the display surface which is common to the first and second positions overlapping with each other. Specifically described, after the display page containing the color-copy start button is opened by operating the OK button by means of the operation performed in the common portion of the display surface, the color-copy start button can be operated by means of the operation performed in the same common portion of the display surface. That is, when the OK button and the color-copy start button are to be operated sequentially in this order, it is not necessary to change the portion of the display surface in which the operation is to be performed. Thus, an excellent operability can be obtained.

Further, in the multifunction device 1, the letter strings representing the setting items are displayed in the section 31A as a setting-representation displaying position when the setting-item list page 30 is opened, and the currently selected icon is displayed in an icon displaying position when the icon selection page 20 is opened. Although the letter strings are relatively frequently subjected to the sliding movement operation, the currently selected icon is displayed in the icon displaying position that is offset from the setting-representation displaying position of the letter strings, by a given distance, in a horizontal direction (i.e., first direction). Therefore, the currently selected icon can be well visualized.

Moreover, the letter string corresponding to the currently selected icon is displayed in the section 21B, so that the displayed letter string facilitates the user to understand contents of the currently-selected one of the preset option combinations which could be hard to understand only with reference to the corresponding icon. It is noted that the letter string may be, for example, a title given to the icon or a representation describing features of the currently-selected preset option combination. Still further, since the letter string is displayed in the section 21B offset, in the vertical direction (i.e., second direction), from the section 21A in which displayed are the icons that are relatively frequently subjected to the user's operation, a portion of the display surface displaying the letter string is relatively hard to be scratched or get dirty even with the slide operation frequently performed on the icons, so that it is possible to make it easy to confirm content of the letter string.

### Other Embodiments

While the preferred embodiment of the invention has been described above, it is to be understood that the invention is not limited to the details of the illustrated embodiment, but may be otherwise embodied.

For example, in the above-described embodiment, the touch panel portion 16C of the operation panel unit 16 is constituted by the input device capable of detecting a touch operation by means of a known system such as a capacitance system. However, the capacitance system may be replaced by, for example, an electromagnetic induction system, an infrared ray system, an surface acoustic wave system or a resistive film system.

Further, in the above-described embodiment, the touch panel portion 16C is constituted by a single touch panel that is provided commonly for the liquid-crystal display portion 16A and the internal-illumination-type indication portion 16B. However, the touch panel portion 16C may be constituted by two touch panels that are provided for the liquid-crystal display portion 16A and the internal-illumination-type indication portion 16B, respectively. In this case, the two touch panels may be of either the same system or respective different systems. Where the two touch panels are of the respective different systems, it is possible to employ an arrangement in which one of the two touch panels is of a system suitable for an operation performed by a user's fingertip while the other of the two touch panels is of a system suitable for an operation performed by a stylus or pen manipulated by a user, or an arrangement in which one of the two touch panels is of a system having a high degree of resolution while the other of the two touch panels is an inexpensive system having a low degree of resolution.

Further, in the above-described embodiment, the operation panel unit 16 includes the liquid-crystal display portion 16A as the display device and the touch panel portion 16C as the input device which are superposed on each other, so that the operation panel unit 16 as a whole has both of display and input functions. However, the operation panel unit 16 may include a single device having both of display and input functions.

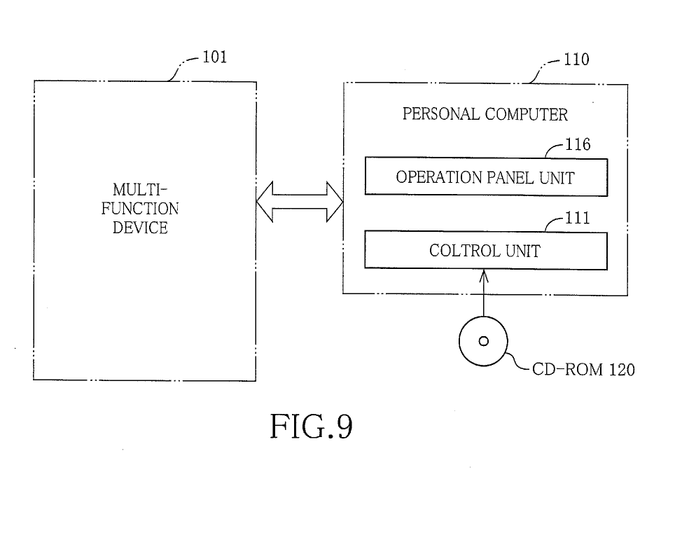

Further, in the above-described embodiment as a first embodiment of the invention, at least a part of the multifunction device 1 constitutes the information processing device, so that the control unit 11 included in the multifunction device 1 serves as the processing controller that is configured to control a processing, and the operation panel unit 16 included in the multifunction device 1 serves as a display unit that is configured to display a representation and to receive a user's operation that is to be performed, by a user, onto the displayed representation. However, as in a second embodiment shown in FIG. 9, the information processing device may be constituted by at least a part of a smart phone or personal computer 110, which is to be connected to a multifunction device 101. In this second embodiment shown in FIG. 9, the personal computer 110 includes a control unit 111 and an operation panel unit 116. The control unit 111 includes a CPU; a CD-ROM drive configured to read programs stored in a CD-ROM 120 as a computer-readable recording medium; and a drive interface interconnecting the CPU and the CD-ROM 120.

The programs, in accordance with which routines similar to the routines shown in FIGS. 2-4 are to be carried out, are transferred from the CD-ROM 120 to the CPU of the control unit 111 of the personal computer 110 that is connected to the multifunction device 101, so that the control unit 111 serves as a processing controller that is configured to control a processing, and the operation panel unit 116 serves as a display unit that is configured to display a representation and to receive a user's operation that is to be performed, by a user, onto the displayed representation. In this second embodiment, the control unit 111 constitutes the processing controller, a preset option-combination storage, an icon display controller, an icon scroll controller, a relating-object display controller, a setting-representation display controller, a setting-representation scroll controller and a selected option storage controller, like the control unit 11 in the above-described first embodiment. Further, in this second embodiment, the display pages shown in FIGS. 6A, 6B, 7A, 7B, 8A and 8B are displayed in a display portion of the operation panel unit 116 that is included in the personal computer 110.

In the description regarding the above-described embodiments, there have been described the input/output processings that are to be executed in a case of change of a selected option for a setting item that relates to the copy function. However, also in a case of change of a selected option for a setting item that relates to another function such as a scan function and a facsimile function, the change can be made by means of user-interface-related activities that are substantially the same as described above.

Further, in the above-described first embodiment, the information processing device is constituted by the multifunction device 1 having facsimile, scan and copy functions. However, the information processing device may be constituted by a single function device such as a printer, an image scanner and a facsimile device. Still further, in the above-described second embodiment, the information processing device, which is constituted by the smart phone or personal computer 110, is to be connected to the multifunction device 101. However, the smart phone or personal computer 110 may be connected to a single function device such as a printer, an image scanner and a facsimile device, so that the single function device is to be subjected to control by the smart phone or personal computer 110. In this case, a user's operation and a display procedure are performed for controlling the single function device, by carrying out routines similar to the routines shown in FIGS. 2-4, in accordance with the programs installed in the smart phone or personal computer 110. The present invention is applicable also in a case of change of a selected option for a setting item that relates to the smart phone or personal computer 110, i.e., the information processing device as such, as long as the smart phone or personal computer 110 has a display unit with a touch panel.

Further, in the description regarding the above-described first embodiment, there have been described, by way of example, the arrangement in which the information representing the selected options of a currently-selected one of the preset option combinations is displayed in the second displaying region 22 (see FIGS. 6A and 6B) and the shortcut register button is displayed in the second displaying region 32, 42 (see FIGS. 7A, 7B, 8A and 8B). However, in the second displaying regions 22, 32, 42, it is possible to display also an information representing an option that is available for the user; a button graphic (e.g., detailed setting button) that is to be subjected to the user's operation when change of each of at least one of the selected options included in the currently-selected preset option combination into another option is to be commanded by the user's operation; and/or a button graphic (e.g., monochrome-copy start button, color-copy start button) that is to be subjected to the user's operation when the image processing in accordance with the currently-selected preset option combination is to be commanded by the user's operation.

What is claimed is:

1. An information processing device comprising:
an image processor including an image reading unit configured to read an image from an original and/or an image forming unit configured to form an image onto a recording medium,
a processing controller configured to control a processing;
a display unit configured to display a representation and to receive a user's operation that is to be performed, by a user, onto the displayed representation;
a preset option-combination storage configured to store a plurality of preset option combinations, each of the preset option combinations including selected options selected for respective setting items that relate to the processing controlled by said processing controller, each of the selected options being selected from a plurality of selectable options that are selectable for a corresponding one of the setting items;
an icon display controller configured to cause said display unit to display, as the representation, a plurality of icons representing the respective preset option combinations such that the plurality of icons are displayed in a first displaying region of said display unit and are arranged in a first direction and such that one of the icons is displayed in a selected-status indicating manner while the other of the icons is displayed in a non-selected-status indicating manner that is different from the selected-status indicating manner;
an icon scroll controller configured to cause said display unit to scroll the plurality of icons in the first direction, when it is recognized that the received user's operation is performed in the first displaying region and that the received user's operation performed in the first displaying region is constituted by a slide movement in the first direction;
a relating-object display controller configured to cause said display unit to display, as the representation, a relating object that relates to one of the preset option combinations represented by said one of the icons displayed in the selected-status indicating manner such that the relating object is displayed in a second displaying region that is offset from the first displaying region, by a given distance, in a second direction perpendicular to the first direction;
said processing controller being configured, when it is recognized that initiation of the processing is commanded by the received user's operation, to control the processing in accordance with said one of the preset option combinations represented by said one of the icons displayed in the selected-status indicating manner; and
said processing controller including an image processing controller configured, when it is recognized that initiation of an image processing as the processing is commanded by the received user's operation, to cause said image processor to carry out the image processing by controlling said image processor in accordance with said one of the preset option combinations.

2. The information processing device according to claim 1,
wherein said image processor includes said image reading unit and said image forming unit,
wherein said preset option-combination storage is configured to store, as the plurality of preset option combinations, a plurality of scan-function-related preset option combinations that relate to a scan function performed by said image reading unit and a plurality of copy-function-related preset option combinations that relate to a copy function performed by cooperation of said image reading unit and said image forming unit,
said information processing device comprising, in addition to said icon display controller as a second icon display controller, a first icon display controller configured to cause said display unit to display, as the representation, at least a scan-function-selection icon and a copy-function-selection icon that are to be selected by the user's operation,
wherein said second icon display controller is configured to cause said display unit to display, as the plurality of icons, a plurality of scan-function-preset-option-combination icons representing the respective scan-function-related preset option combinations, when the scan-function-selection icon is selected by the user's operation, such that ones of the scan-function-preset-option-combination icons representing corresponding ones of the scan-function-related preset option combinations are displayed at a time, wherein a number of said corresponding ones of the scan-function-related preset option combinations is equal to a maximum number of icons that are displayable at a time,
and wherein said second icon display controller is configured to cause said display unit to display, as the plurality of icons, a plurality of copy-function-preset-option-combination icons representing the respective copy-function-related preset option combinations, when the copy-function-selection icon is selected by the user's operation, such that ones of the copy-function-preset-option-combination icons representing corresponding ones of the copy-function-related preset option combinations are displayed at a time, wherein a number of said corresponding ones of the copy-function-related preset option combinations is equal to the maximum number of icons that are displayable at a time,
said information processing device comprising a setting-representation display controller configured, when it is recognized that display of the setting items and/or the selected options of the preset option combinations is commanded by the received user's operation, to cause said display unit to display, as the representation, the setting items and/or the selected options that are included in said one of the preset option combinations, such that ones of the setting items and/or ones of the selected options are displayed at a time, wherein a number of said ones of the setting items is equal to a maximum number of items that are displayable at a time, and wherein a number of said ones of the selected options is equal to a maximum number of options that are displayable at a time.

3. The information processing device according to claim 1,
wherein said display unit is configured to display the representation on a display surface thereof, and is configured, when a pointing body is brought into contact or approximation with said display surface, to output a position information representing a position of a portion of said display surface with which the pointing body is brought into contact or approximation,
and wherein said icon scroll controller is configured to cause said display unit to scroll the plurality of icons in the first direction, when it is recognized that the position represented by the position information is located in the first displaying region at a point of time and that the position represented by the position information is displaced in the first direction during a period between consecutive two of discrete points of time that follow said point of time.

4. The information processing device according to claim 1, comprising:
a setting-representation display controller configured, when it is recognized that display of the setting items and/or the selected options of the preset option combinations is commanded by the received user's operation, to cause said display unit to display, as the representation, a plurality of setting representations representing the setting items and/or the selected options that are included in said one of the preset option combinations, such that the plurality of setting representations are displayed in a third displaying region of said display unit and are arranged in the second direction;
a setting-representation scroll controller configured to cause said display unit to scroll the plurality of setting representations in the second direction, when it is recognized that the received user's operation is performed in the third displaying region and that the received user's operation performed in the third displaying region is constituted by a slide movement in the second direction; and
a selected option storage controller configured, when it is recognized that change of each of at least one of the selected options included in said one of the preset option combinations into another option is commanded by the received user's operation, to cause a selected option storage to store said another option,
wherein said relating-object display controller is configured to cause said display unit to display the relating object in the second displaying region which is offset from the first displaying region by the given distance in the second direction and which is offset from the third displaying region by a given distance in the first direction.

5. The information processing device according to claim 4,
wherein said display unit is configured to display the representation on a display surface thereof, and is configured, when a pointing body is brought into contact or approximation with said display surface, to output a position information representing a position of a portion of said display surface with which the pointing body is brought into contact or approximation,
and wherein said icon scroll controller is configured to cause said display unit to scroll the plurality of icons in the first direction, when it is recognized that the position represented by the position information is located in the first displaying region at a point of time and that the position represented by the position information is displaced in the first direction during a period between consecutive two of discrete points of time that follow said point of time.

6. The information processing device according to claim 1, comprising:
a setting-representation display controller configured, when it is recognized that display of the setting items and/or the selected options of the preset option combinations is commanded by the received user's operation, to cause said display unit to display, as the representation, a plurality of setting representations representing the setting items and/or the selected options that are included in said one of the preset option combinations, such that the plurality of setting representations are displayed in a third displaying region of said display unit and are arranged in the second direction;
a setting-representation scroll controller configured to cause said display unit to scroll the plurality of setting representations in the second direction, when it is recognized that the received user's operation is performed in the third displaying region and that the received user's operation performed in the third displaying region is constituted by a slide movement in the second direction; and
a selected option storage controller configured, when it is recognized that change of each of at least one of the selected options included in said one of the preset option combinations into another option is commanded by the received user's operation, to cause a selected option storage to store said another option,
wherein said relating-object display controller is configured to cause said display unit to display the relating object in the second displaying region which is offset from the first displaying region by the given distance in the second direction and which is offset from the third displaying region by a given distance in the first direction.

7. The information processing device according to claim 3, comprising:
a setting-representation display controller configured, when it is recognized that display of the setting items and/or the selected options of the preset option combinations is commanded by the received user's operation, to cause said display unit to display, as the representation, a plurality of setting representations representing the setting items and/or the selected options that are included in said one of the preset option combinations, such that the plurality of setting representations are displayed in a third displaying region of said display unit and are arranged in the second direction;
a setting-representation scroll controller configured to cause said display unit to scroll the plurality of setting representations in the second direction, when it is recognized that the position represented by the position information is located in the third displaying region at a point of time and that the position represented by the position information is displaced in the second direction during a period between consecutive two of discrete points of time that follow said point of time,
a selected option storage controller configured, when it is recognized that change of each of at least one of the selected options included in said one of the preset option combinations into another option is commanded by the received user's operation, to cause a selected option storage to store said another option;
wherein said relating-object display controller is configured to cause said display unit to display the relating object in the second displaying region which is offset from the first displaying region by the given distance in the second direction and which is offset from the third displaying region by a given distance in the first direction.

8. The information processing device according to claim 1, wherein said relating-object display controller is configured to cause said display unit to display, as the relating object, each of (i) an information representing the selected options included in said one of the preset option combinations which is represented by said one of the icons displayed in the selected-status indicating manner, (ii) an information representing an option that is available for the user when said image processor is to be controlled by said image processing controller in accordance with said one of the preset option combinations which is represented by said one of the icons displayed in the selected-status indicating manner, (iii) a button graphic that is to be subjected to the user's operation when change of each of at least one of the selected options included in said one of the preset option combinations into another option is to be commanded by the user's operation, and/or (iv) a button graphic that is to be subjected to the user's operation when the image processing in accordance with said one of the preset option combinations is to be commanded by the user's operation.

9. The information processing device according to claim 1,
wherein said display unit is configured to display the representation on a display surface thereof,
and wherein said relating-object display controller is configured to cause said display unit to display the relating object in the second displaying region which is offset from the first displaying region by the given distance in the second direction and which is located in one of end portions of said display surface that are opposite to each other in the first direction.

10. The information processing device according to claim 1, wherein said icon display controller is configured, when causing said display unit to display said one of the icons in the selected-status indicating manner in the first displaying region, to cause said display unit to display, as the representation, a letter string corresponding to said one of the icons such that the letter string is displayed in a position which is adjacent to said one of the icons and which is offset from said one of the icons in the second direction.

11. The information processing device according to claim 1, comprising a setting-representation display controller configured, when it is recognized that display of the setting items and/or the selected options of the preset option combinations is commanded by the received user's operation, to cause said display unit to display, as the representation, a plurality of setting representations representing the setting items and/or the selected options that are included in said one of the preset option combinations, such that the plurality of setting representations are displayed in a third displaying region of said display unit and are arranged in the second direction,
wherein said relating-object display controller is configured to cause said display unit to display, as the relating object, each of (i) an information representing the selected options included in said one of the preset option combinations which is represented by said one of the icons displayed in the selected-status indicating manner, (ii) an information representing an option that is available for the user when the processing is to be controlled by said processing controller in accordance with said one of the preset option combinations which is represented by said one of the icons displayed in the selected-status indicating manner, (iii) a button graphic that is to be subjected to the user's operation when change of each of at least one of the selected options included in said one of the preset option combinations into another option is to be commanded by the user's operation, and/or (iv) a button graphic that is to be subjected to the user's operation when the processing in accordance with said one of the preset option combinations is to be commanded by the user's operation,
and wherein said relating-object display controller is configured to cause said display unit to display the relating object in the second displaying region when the plurality of setting representations are displayed in the third displaying region, without causing said display unit to display the relating object in the second displaying region when the plurality of icons are displayed in the first displaying region.

12. The information processing device according to claim 1, comprising a setting-representation display controller configured, when it is recognized that display of the setting items and/or the selected options of the preset option combinations is commanded by the received user's operation, to cause said display unit to display, as the representation, a plurality of setting representations representing the setting items and/or the selected options that are included in said one of the preset option combinations, such that the plurality of setting representations are displayed in a third displaying region of said display unit and are arranged in the second direction,
wherein said relating-object display controller is configured, when the plurality of setting representations are displayed in the third displaying region, to cause said display unit to display, as the relating object, (α) a first button graphic that is to be subjected to the user's operation when the processing in accordance with said one of the preset option combinations is to be commanded by the user's operation or (β) a second button graphic that is to be subjected to the user's operation when opening of a display page containing the first button graphic is to be commanded by the user's operation, such that the first or second button graphic is displayed in the second displaying region which is offset from the first displaying region by the given distance in the second direction and which is offset from the third displaying region by the given distance in the first direction.

13. The information processing device according to claim 1, comprising a setting-representation display controller configured, when it is recognized that display of the setting items and/or the selected options of the preset option combinations is commanded by the received user's operation, to cause said display unit to display, as the representation, a plurality of setting representations representing the setting items and/or the selected options that are included in said one of the preset option combinations, such that the plurality of setting representations are displayed in a third displaying region of said display unit and are arranged in the second direction,
wherein said relating-object display controller is configured, when the plurality of icons are displayed in the first displaying region, to cause said display unit to display, as the relating object, a first button graphic that is to be subjected to the user's operation when the processing in accordance with said one of the preset option combinations is to be commanded by the user's operation, such that the first button graphic is displayed in a first position located in the second displaying region which is offset from the first displaying region by the given distance in the second direction and which is offset from the third displaying region by the given distance in the first direction,
and wherein said relating-object display controller is configured, when the plurality of setting representations are displayed in the third displaying region, to cause said display unit to display, as the relating object, a second button graphic that is to be subjected to the user's operation when opening of a display page containing the first button graphic is to be commanded by the user's operation, such that the second button graphic is displayed in a second position which is located in the second displaying region and which overlaps with the first position.

14. The information processing device according to claim 1, comprising a setting-representation display controller configured, when it is recognized that display of the setting items and/or the selected options of the preset option combinations is commanded by the received user's operation, to cause said display unit to display, as the representation, a plurality of setting representations representing the setting items and/or the selected options that are included in said one of the preset option combinations, such that the plurality of setting representations are displayed in a third displaying region of said display unit and are arranged in the second direction,
wherein said setting-representation display controller is configured to cause said display unit to display, as the setting representations, letter strings representing the setting items for which the selected options are selected, such that the letter strings are displayed in a setting-representation displaying position located in the third displaying region,
and wherein said icon display controller is configured to cause said display unit to display said one of the icons in the selected-status indicating manner and to display, as the representation, a letter string corresponding to said one of the icons, such that said one of the icons is displayed in an icon displaying position which is located in the first displaying region and which is offset from the setting-representation displaying position, by a given distance, in the first direction, and such that the letter string is displayed in a position which is located in the first displaying region and which is adjacent to and offset from said one of the icons in the second direction.

15. The information processing device according to claim 1, wherein said icon scroll controller is configured not to cause said display unit to scroll the plurality of icons in the first direction, as long as it is recognized that the received user's operation is performed in the second displaying region rather than in the first displaying region, even with a recognition that the received user's operation is constituted by a slide movement in the first direction.

16. The information processing device according to claim 1, comprising:
a setting-representation display controller configured, when it is recognized that display of the setting items and/or the selected options of the preset option combinations is commanded by the received user's operation, to cause said display unit to display, as the representation, a plurality of setting representations representing the setting items and/or the selected options that are included in said one of the preset option combinations, such that the plurality of setting representations are displayed in a third displaying region of said display unit and are arranged in the second direction; and
a setting-representation scroll controller configured to cause said display unit to scroll the plurality of setting representations in the second direction, when it is recognized that the received user's operation is performed in the third displaying region and that the received user's operation performed in the third displaying region is constituted by a slide movement in the second direction,
wherein said setting-representation scroll controller is configured not to cause said display unit to scroll the plurality of setting representations in the second direction, as long as it is recognized that the received user's operation is performed in the second displaying region rather than in the third displaying region, even with a recognition that the received user's operation is constituted by a slide movement in the second direction.

17. An information processing device comprising:
a processing controller configured to control a processing;
a display unit configured to display a representation and to receive a user's operation that is to be performed, by a user, onto the displayed representation;
a preset option-combination storage configured to store a plurality of preset option combinations, each of the preset option combinations including selected options selected for respective setting items that relate to the processing controlled by said processing controller, each of the selected options being selected from a plurality of selectable options that are selectable for a corresponding one of the setting items;
an icon display controller configured to cause said display unit to display, as the representation, a plurality of icons representing the respective preset option combinations such that the plurality of icons are displayed in a first displaying region of said display unit and are arranged in a first direction and such that one of the icons is displayed in a selected-status indicating manner while the other of the icons is displayed in a non-selected-status indicating manner that is different from the selected-status indicating manner;
an icon scroll controller configured to cause said display unit to scroll the plurality of icons in the first direction, when it is recognized that the received user's operation is performed in the first displaying region and that the received user's operation performed in the first displaying region is constituted by a slide movement in the first direction;
a relating-object display controller configured to cause said display unit to display, as the representation, a relating object that relates to one of the preset option combinations represented by said one of the icons displayed in the selected-status indicating manner such that the relating object is displayed in a second displaying region that is offset from the first displaying region, by a given distance, in a second direction perpendicular to the first direction;
a setting-representation display controller configured, when it is recognized that display of the setting items and/or the selected options of the preset option combinations is commanded by the received user's operation, to cause said display unit to display, as the representation, a plurality of setting representations representing the setting items and/or the selected options that are included in said one of the preset option combinations, such that the plurality of setting representations are displayed in a third displaying region of said display unit and are arranged in the second direction;
a setting-representation scroll controller configured to cause said display unit to scroll the plurality of setting representations in the second direction, when it is recognized that the received user's operation is performed in the third displaying region and that the received user's operation performed in the third displaying region is constituted by a slide movement in the second direction;
a selected option storage controller configured, when it is recognized that change of each of at least one of the selected options included in said one of the preset option combinations into another option is commanded by the received user's operation, to cause a selected option storage to store said another option;
said processing controller being configured, when it is recognized that initiation of the processing is commanded by the received user's operation, to control the processing in accordance with said one of the preset option combinations represented by said one of the icons displayed in the selected-status indicating manner; and
said relating-object display controller being configured to cause said display unit to display the relating object in the second displaying region which is offset from the first displaying region by the given distance in the second direction and which is offset from the third displaying region by a given distance in the first direction.

18. The information processing device according to claim 17,
wherein said display unit is configured to display the representation on a display surface thereof, and is configured, when a pointing body is brought into contact or approximation with said display surface, to output a position information representing a position of a portion of said display surface with which the pointing body is brought into contact or approximation,
and wherein said icon scroll controller is configured to cause said display unit to scroll the plurality of icons in the first direction, when it is recognized that the position represented by the position information is located in the first displaying region at a point of time and that the position represented by the position information is displaced in the first direction during a period between consecutive two of discrete points of time that follow said point of time.

19. The information processing device according to claim 17,
wherein said relating-object display controller is configured to cause said display unit to display, as the relating object, each of (i) an information representing the selected options included in said one of the preset option combinations which is represented by said one of the icons displayed in the selected-status indicating manner, (ii) an information representing an option that is available for the user when the processing is to be controlled by said processing controller in accordance with said one of the preset option combinations which is represented by said one of the icons displayed in the selected-status indicating manner, (iii) a button graphic that is to be subjected to the user's operation when change of each of at least one of the selected options included in said one of the preset option combinations into another option is to be commanded by the user's operation, and/or (iv) a button graphic that is to be subjected to the user's operation when the processing in accordance with said one of the preset option combinations is to be commanded by the user's operation,
and wherein said relating-object display controller is configured to cause said display unit to display the relating object in the second displaying region when the plurality of setting representations are displayed in the third displaying region, without causing said display unit to display the relating object in the second displaying region when the plurality of icons are displayed in the first displaying region.

20. The information processing device according to claim 17, wherein said relating-object display controller is configured, when the plurality of setting representations are displayed in the third displaying region, to cause said display unit to display, as the relating object, (α) a first button graphic that is to be subjected to the user's operation when the processing in accordance with said one of the preset option combinations is to be commanded by the user's operation or (β) a second button graphic that is to be subjected to the user's operation when opening of a display page containing the first button graphic is to be commanded by the user's operation, such that the first or second button graphic is displayed in the second displaying region which is offset from the first displaying region by the given distance in the second direction and which is offset from the third displaying region by the given distance in the first direction.

21. The information processing device according to claim 17,
wherein said relating-object display controller is configured, when the plurality of icons are displayed in the first displaying region, to cause said display unit to display, as the relating object, a first button graphic that is to be subjected to the user's operation when the processing in accordance with said one of the preset option combinations is to be commanded by the user's operation, such that the first button graphic is displayed in a first position located in the second displaying region which is offset from the first displaying region by the given distance in the second direction and which is offset from the third displaying region by the given distance in the first direction,
and wherein said relating-object display controller is configured, when the plurality of setting representations are displayed in the third displaying region, to cause said display unit to display, as the relating object, a second button graphic that is to be subjected to the user's operation when opening of a display page containing the first button graphic is to be commanded by the user's operation, such that the second button graphic is displayed in a second position which is located in the second displaying region and which overlaps with the first position.

22. The information processing device according to claim 17,
wherein said setting-representation display controller is configured to cause said display unit to display, as the setting representations, letter strings representing the setting items for which the selected options are selected, such that the letter strings are displayed in a setting-representation displaying position located in the third displaying region,
and wherein said icon display controller is configured to cause said display unit to display said one of the icons in the selected-status indicating manner and to display, as the representation, a letter string corresponding to said one of the icons, such that said one of the icons is displayed in an icon displaying position which is located in the first displaying region and which is offset from the setting-representation displaying position, by a given distance, in the first direction, and such that the letter string is displayed in a position which is located in the first displaying region and which is adjacent to and offset from said one of the icons in the second direction.

23. The information processing device according to claim 17, wherein said icon scroll controller is configured not to cause said display unit to scroll the plurality of icons in the first direction, as long as it is recognized that the received user's operation is performed in the second displaying region rather than in the first displaying region, even with a recognition that the received user's operation is constituted by a slide movement in the first direction.

24. The information processing device according to claim 17, wherein said setting-representation scroll controller is configured not to cause said display unit to scroll the plurality of setting representations in the second direction, as long as it is recognized that the received user's operation is performed in the second displaying region rather than in the third displaying region, even with a recognition that the received user's operation is constituted by a slide movement in the second direction.

25. A computer-readable recording medium storing a control program that is to be used for the information processing device recited in claim 1, wherein the control program stored in said computer-readable recording medium is to be executed for causing a control unit included in said information processing device, to function as said processing controller, said icon display controller, said icon scroll controller and said relating-object display controller.

26. The computer-readable recording medium according to claim 25,
wherein said display unit is configured to display the representation on a display surface thereof, and is configured, when a pointing body is brought into contact or approximation with said display surface, to output a position information representing a position of a portion of said display surface with which the pointing body is brought into contact or approximation,
and wherein said icon scroll controller is configured to cause said display unit to scroll the plurality of icons in the first direction, when it is recognized that the position represented by the position information is located in the first displaying region at a point of time and that the position represented by the position information is displaced in the first direction during a period between consecutive two of discrete points of time that follow said point of time.

27. A computer-readable recording medium storing a control program that is to be used for the information processing device recited in claim 17, wherein the control program stored in said computer-readable recording medium is to be executed for causing a control unit included in said information processing device, to function as said processing controller, said icon display controller, said icon scroll controller, said relating-object display controller, said setting-representation display controller, said setting-representation scroll controller and said selected option storage controller.

28. The computer-readable recording medium according to claim 27,
wherein said display unit is configured to display the representation on a display surface thereof, and is configured, when a pointing body is brought into contact or approximation with said display surface, to output a position information representing a position of a portion of said display surface with which the pointing body is brought into contact or approximation,
and wherein said icon scroll controller is configured to cause said display unit to scroll the plurality of icons in the first direction, when it is recognized that the position represented by the position information is located in the first displaying region at a point of time and that the position represented by the position information is displaced in the first direction during a period between consecutive two of discrete points of time that follow said point of time.
